(19) United States
(12) Patent Application Publication
(10) Pub. No.: US 2013/0250300 A1
(43) Pub. Date: Sep. 26, 2013

(54) LIGHT SOURCE RECOGNITION

(71) Applicant: Po-Chieh Hung, Cupertino, CA (US)

(72) Inventor: Po-Chieh Hung, Cupertino, CA (US)

(21) Appl. No.: 13/849,371

(22) Filed: Mar. 22, 2013

Related U.S. Application Data
(60) Provisional application No. 61/615,134, filed on Mar. 23, 2012.

(51) Int. Cl. G01N 21/25

(52) U.S. Cl. CPC G01N 21/25
USPC 356/402

(57) ABSTRACT

A method for light source recognition in an environment includes obtaining, by a computing device, a measured power spectral distribution (PSD) for an unknown light source illuminating the environment. The method further includes obtaining, by the computing device, an information item for the unknown light source and identifying, based on at least the information item, a candidate light sources for the unknown light source illuminating the environment. The method further includes obtaining stored PSDs for the candidate light sources, calculating weights for the stored PSDs based on the measured PSD and a composite PSD and outputting an identity of at least one of the candidate light sources.

### CROSS-REFERENCE TO RELATED APPLICATIONS

This application claims priority, pursuant to 35 U.S.C. §119(e), to U.S. Provisional Application No. 61/615,134, filed on Mar. 23, 2012, the entirety of which is incorporated by reference herein.

### BACKGROUND

An environment may be illuminated using any number and various types of light sources. However, the identities (e.g., type, model, brand, manufacturer, etc.) of the light sources may be unknown to a user (e.g., architectural designer) in the environment. Regardless, the user may want to know the various types of lights sources being used to illuminate the environment. For example, the user may want to know the identities of the unknown light sources because the illumination is aesthetically pleasing to the user.

### SUMMARY

In general, in one aspect, the invention relates to a method for light source recognition in an environment. The method includes obtaining, by a computing device, a measured power spectral distribution (PSD) and an information item for an unknown light source illuminating the environment. The method further includes identifying, based on at least the information item, a plurality of candidate light sources for the unknown light source and obtaining a plurality of stored PSDs for the plurality of candidate light sources. The method further includes calculating a plurality of weights for the plurality of stored PSDs based on the measured PSD and a composite PSD, wherein the composite PSD is based on the plurality of stored PSDs and outputting an identity of at least one of the plurality of candidate light sources.

In general, in one aspect, the invention relates to a non-transitory computer readable medium storing instructions for light source recognition in an environment. The instructions include functionality for obtaining, by a computing device, a measured power spectral distribution (PSD) and an information item for an unknown light source illuminating the environment. The instructions further include functionality for identifying, based on at least the information item, a plurality of candidate light sources for the unknown light source and functionality for obtaining a plurality of stored PSDs for the plurality of candidate light sources. The instructions further include functionality for calculating a plurality of weights for the plurality of stored PSDs based on the measured PSD and a composite PSD, wherein the composite PSD is based on the plurality of stored PSDs and outputting an identity of at least one of the plurality of light sources.

In general, in one aspect, the invention relates a system for light source recognition in an environment. The system includes a spectrometer configured to obtain a power spectral distribution (PSD) for an unknown light source illuminating the environment. The system further includes an estimation engine executing on a processor and configured to identify, based on an information item of the unknown light source, a plurality of candidate light sources for the unknown light source. The estimation engine is further configured to obtain a plurality of stored PSDs for the plurality of candidate light sources and calculate a plurality of weights for the plurality of stored PSDs by comparing the measured PSD with a composite PSD. The composite PSD is based on the plurality of stored PSDs. The system further includes a screen for displaying an identity of at least one of the plurality of candidate light sources.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3 shows a workflow in accordance with one or embodiments of the invention.

FIG. 4 shows an example power spectral distribution in accordance with one or embodiments of the invention.

FIG. 5 shows a computer system in accordance with one or embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention include identifying one or more candidate (i.e., possible) light sources (e.g., sunlight, incandescent lamp, fluorescent lamp, light-emitting diode, organic light-emitting diode (OLED), etc.) illuminating an environment based on a measured power spectral distribution (PSD) of the environment; a timestamp associated with the measured PSD; one or more geographic items associated with the environment; measured flicker; and/or measured luminance. Stored PSDs for the candidate light sources may be retrieved and a composite PSD may be calculated by weighting and combining the retrieved PSDs. The various weights assigned to the retrieved PSD may be repeatedly revised in an attempt to match the resulting composite PSD to the measured PSD or, analytical calculation, such as the least-squares method, can be employed. The identities (e.g., light source type, model, brand, manufacturer, etc.) of one or more of the candidate light sources and the probabilities that the one or more candidate light sources are present may be outputted (e.g., printed, displayed, emailed, texted, faxed, etc.) to a user.

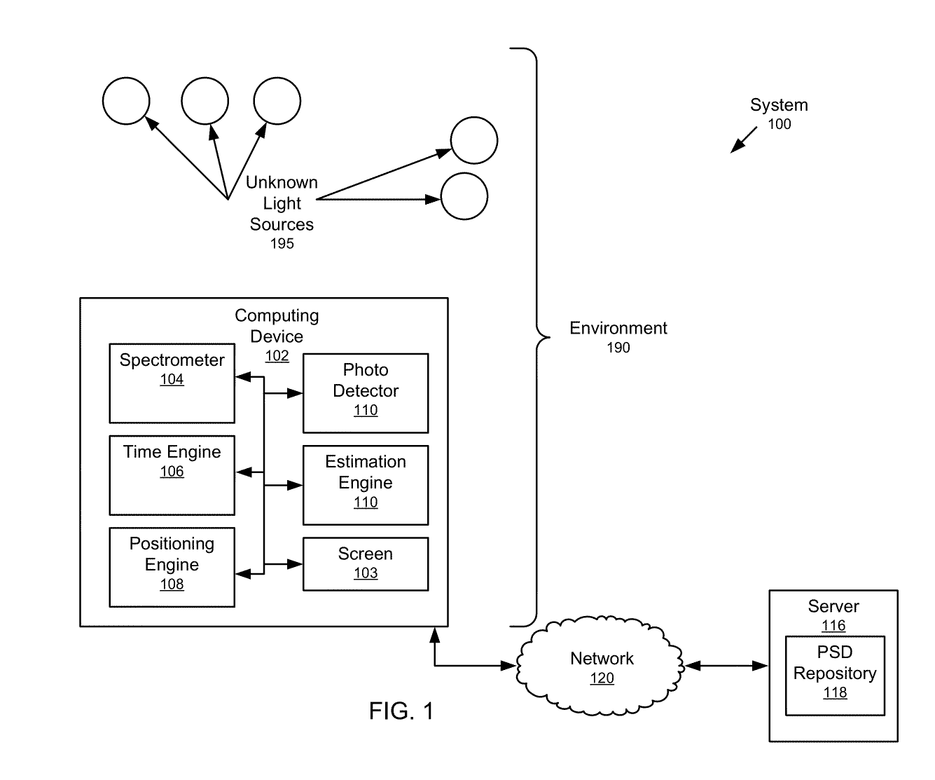

FIG. 1 shows a system (100) in accordance with one or more embodiments of the invention. As shown in FIG. 1, the system (100) includes one or more unknown light sources (195) illuminating an environment (190) occupied by a user (not shown). In other words, although the unknown light sources (195) are present, the user is unaware of the identities (i.e., type, model, brand, manufacturer, etc.) of the unknown light sources (195).

As also shown in FIG. 1, the system (100) includes a computing device (102) operated by the user. The computing device (102) may be a mobile computing device. The computing device may be a personal computer (PC), a laptop, a smart phone, a tablet, a personal digital assistant (PDA), a kiosk, a cable box, or any other computing hardware device. The computing device (102) is configured to communicate with one or more servers (e.g., Server (116)) using the network (120). Moreover, the network (120) may be any type of network (e.g., cellular network, Internet, etc.) having wired and/or wireless segments.

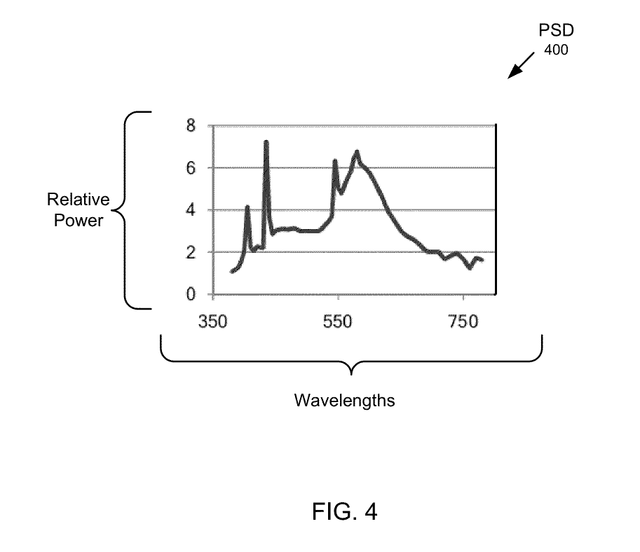

In one or more embodiments of the invention, the computing device (102) includes a spectrometer (104). The spectrometer (104) is configured to measure a PSD of the environment (190). The PSD is a function mapping wavelengths (X) to power. For example FIG. 4 shows one example of a PSD (400) that may be obtained by the spectrometer (104). In this example, the PSD comprises sunlight having a 6234 K color temperature and a spectral weight of 40 percent; incandescent light having a color temperature of 2863 K and a spectral weight of 20 percent; and fluorescent light having a color temperature of 3400 K and a spectral weight of 40 percent. Furthermore, in this example, the light has a color rendering index (CRI), Rₐ of 80; a distance from the Plankian locus (Duv) of 2, a correlated color temperature (CCT) of 4232 K, and an illuminance of 426 lux.

In one or more embodiments of the invention, the computing device (102) includes a time engine (106). The time engine (106) is configured to generate a timestamp associated with the measured PSD. For example, the timestamp may be generated when measurement of the PSD is initiated. As another example, the timestamp may be generated when measurement of the PSD is completed. As yet another example, the timestamp may be generated during the measurement of the PSD. The timestamp may include both the date and/or time. The timestamp may correspond to the time at which the measured PSD was present. In one or more embodiments, the timestamp may be obtained from a global positioning (GPS) signal, a Wi-Fi signal, a cellular telephone signal, or a signal from any wired or wireless network.

In one or more embodiments of the invention, the computing device (102) includes a positioning engine (108). The positioning engine (108) may be used to generate one or more geographical items associated with the environment (190). The geographical item may include the GPS coordinates of the computing device (102) and thus the environment (190). The geographical item may include the altitude of the computing device (102) and thus the environment (190). The geographical item may include the compass direction of the computing device (104) within the environment (190). In addition, location data may be obtained based on the cellular communication system. For example, the location of the computing device may be determined based on base station (or cell) the computing device is assigned to when the PSD was acquired. Furthermore, the location of the computing device may be determined using information available through any available Wi-Fi networks. Manual input of location by user is also possible.

Those skilled in the art, having the benefit of this detailed description, will appreciate that many parameters associated with the environment (190) may be retrieved/calculated based on the timestamp and/or the geographic item. For example, the country/region/city in which the environment (190) is located may be determined from the GPS coordinates. As another example, the weather (e.g., rainy, cloudy, dry, etc.) near the environment (190) may be determined by accessing a weather database (not shown) using the GPS coordinates and the timestamp as search criteria. As yet another example, the existence of sunlight illuminating the environment may be determined based on the timestamp. As a further example, the location of the sun in the sky, as observed from the environment (190), may be determined based on the timestamp and geographical item. One or more of the parameters may be input by the user. For example, the altitude of the sun in the sky may be determined based on the local time (non-daylight savings time) and the location information. Furthermore, the local time may be calculated from location information (e.g., longitude) and Greenwich sidereal time (GST).

In one or more embodiments of the invention, the computing device (102) includes a photo detector (110). The photo detector (110) is configured to measure the flicker and/or luminance in the environment (190). For example, in one or more embodiments, the photo detector (11) may be used to detect whether a 50 Hz or 60 Hz flicker is present.

In one or more embodiments of the invention, the computing device (102) includes an estimation engine (110). The estimation engine (110) is configured to identify (i.e., by type, model, brand, manufacturer, etc.) one or more candidate light sources illuminating the environment (190). In other words, the estimation engine (110) is configured to identify one or more candidate light sources for the unknown light sources (195). The estimation engine (110) may determine the candidate light sources based on any information item(s) of the unknown light source(s) (e.g., the timestamp, the geographical item, the measured flicker, the measured luminance, and/or any other parameter).

For example, if it is determined that the environment (190) is located in Japan, lights sources that are popular, or possess a large market share, in Japan will be considered candidate light sources. For example, standard illuminants F10-F12 may be chosen for candidate light sources because these three-wavelength (tri-band) type fluorescent lamps have a large market share in Japan. Lights sources that are rare, or possess a minimal market share, in Japan will not be considered candidate light sources (i.e., excluded from consideration as candidate light sources). As another example, if it is determined that the PSD for the environment (190) was measured at 2:00 am, the sun will not be considered a candidate light source (i.e., the sun will be excluded from consideration as a candidate light source). Or, reducing a weighting coefficient gives similar effect. As yet another example, if it is determined that the PSD was measured at 3:00 pm during a rain storm in Chicago, one candidate light source is the sun, as observed through rain, at a position in the sky consistent with Chicago at 3:00 pm. Further still, if the flicker in the environment (190) is measured at 60 Hz, only light sources having 60 Hz flickers will be considered for candidate light sources (i.e., all light sources not having 60 Hz flickers will be excluded from consideration as a candidate light source).

Further examples of information items that may aid in the choice of candidate light sources include altitude of the sun. For example, if the altitude of the sun is high, the daylight illuminants D40-D200 may be chosen. If the altitude of the sun is negative (dawn or dusk time, before sun rise or after sun set), daylight illuminants D100-D200 may be chosen.

Those skilled in the art, having the benefit of this detailed description, will appreciate that the number of candidate light sources may exceed the number of wavelengths in the measured PSD. In such embodiments, each candidate light source may be grouped/placed/assigned into one or more sets. Moreover, the number of candidate light sources in each set is less than the number of wavelengths in the measured PSD. In one or more embodiments of the invention, candidate light sources are initially randomly assigned to a set.

In one or more embodiments of the invention, the estimation engine (110) is configured to obtain the PSD for each of the candidate light sources. For example, the estimation engine (110) may retrieve each PSD from a PSD repository (118) on the server (116). Each of the retrieved PSDs may have been normalized to have the same illuminance (e.g., 100). The measured PSD may be normalized in a similar manner. In one or more embodiments of the invention, the PSD repository (118) is located on the computing device (102). In one or more embodiments of the invention, the estimation engine (110) is located on the server (116) or on a different server (not shown).

In one or more embodiments of the invention, for each set of candidate light sources, the estimation engine is configured to generate/calculate a composite PSD by assigning weights to the obtained PSDs of the candidate light sources in the set, and combining (e.g., summing) the weighted PSDs. The weights may be revised repeatedly in an attempt to generate a composite PSD that matches, within some tolerance, the measured PSD from the spectrometer (104). Any algorithm, linear or non-linear, may be used to determine/calculate the weights. For example, the non-linear iterative Generalized Reduced Gradient (GRG2) Algorithm may be used to determine/calculate the weights.

For example, a measured PSD L that includes a measurement over N wavelengths may be expressed by the following vector:

$$L = [ \begin{matrix}{l}_{{λ}_{1}} \\ ⋮ \\ {l}_{{λ}_{n}} \\ ⋮ \\ {l}_{{λ}_{N}}\end{matrix} ] \qquad ( 1 )$$

Likewise, the calculated composite PSD \hat{L} may be expressed by the vector

$$\hat{L} = [ \begin{matrix}{\hat{l}}_{{λ}_{1}} \\ ⋮ \\ {\hat{l}}_{{λ}_{n}} \\ ⋮ \\ {\hat{l}}_{{λ}_{N}}\end{matrix} ] = {L}_{DB} \cdot W \qquad ( 2 )$$

where L_{DB} is a matrix formed from the PSD's of candidate light sources from the PSD repository and W is a vector of weights. For example, for a case where M possible candidate light sources are chosen based on the information items, the matrix may be expressed as

$${L}_{DB} = [ \begin{matrix}{l}_{1 , {λ}_{1}} & … & {l}_{m , {λ}_{1}} & … & {l}_{M , {λ}_{1}} \\ ⋮ & & ⋮ & & ⋮ \\ {l}_{1 , {λ}_{n}} & … & {l}_{m , {λ}_{n}} & … & {l}_{M , {λ}_{n}} \\ ⋮ & & ⋮ & & ⋮ \\ {l}_{1 , {λ}_{N}} & … & {l}_{m , {λ}_{N}} & … & {l}_{M , {λ}_{N}}\end{matrix} ] \qquad ( 3 )$$

and the weight vector W may be represented as the vector

$$W = [ \begin{matrix}{w}_{1} \\ ⋮ \\ {w}_{m} \\ ⋮ \\ {w}_{M}\end{matrix} ] \qquad ( 4 )$$

where the assumption is made that wₘ≧0. In one embodiment, the weight vector W is found by minimizing the square of the difference between l_{λ}_{ₙ} and \hat{l}_{λ}_{ₙ} for example by minimizing the mean square error between the measurement and the calculated composite PSD. In other words, the composite PSD is found my computing wₘ with the requirement that

min(Σ(l_{λ}_{ₙ}−\hat{l}_{λ}_{ₙ})²) (5)

In many cases, the mobile device based spectrometer may not be accurately calibrated, i.e., there may be some shift in wavelength. In this case, it may be useful to average the measured PSD over wavelength. The averaging process may reduce the estimation error, especially for light sources that have narrow band “spikes” in the measured PSD. Furthermore, if the user is able to identify one or more light sources, PSD's of these known light sources can be selected from the PSD repository and used in the L_{DB} matrix to reduce error in the computation.

In one embodiment, the set of weights W may be found using a smoothing average over wavelength. In this embodiment, the measured PSD L may be expressed as an average measured PSD L̅, where

$$\begin{matrix}\overline{L} = [ \begin{matrix}{\overline{l}}_{{λ}_{1}} \\ ⋮ \\ {\overline{l}}_{{λ}_{n}} \\ ⋮ \\ {\overline{l}}_{{λ}_{N}}\end{matrix} ] \\ and where & ( 6 ) \\ {\overline{l}}_{{λ}_{n}} = ( {l}_{{λ}_{n - 1}} + 2 {l}_{{λ}_{n}} + {l}_{{λ}_{n + 1}} ) / 4. & ( 7 )\end{matrix}$$

Likewise, the matrix formed from the PSD's of candidate light sources may be expressed in average form by

$$\begin{matrix}{\overline{L}}_{DB} = [ \begin{matrix}{\overline{l}}_{1 , {λ}_{1}} & … & {\overline{l}}_{m , {λ}_{1}} & … & {\overline{l}}_{M , {λ}_{1}} \\ ⋮ & & ⋮ & & ⋮ \\ {\overline{l}}_{1 , {λ}_{n}} & … & {\overline{l}}_{m , {λ}_{n}} & … & {\overline{l}}_{M , {λ}_{n}} \\ ⋮ & & ⋮ & & ⋮ \\ {\overline{l}}_{1 , {λ}_{N}} & … & {\overline{l}}_{m , {λ}_{N}} & … & {\overline{l}}_{M , {λ}_{N}}\end{matrix} ] \\ where & ( 8 ) \\ {\overline{l}}_{m , {λ}_{n}} = ( {l}_{m , {λ}_{n - 1}} + 2 {l}_{{λ}_{m , n}} + {l}_{m , {λ}_{n + 1}} ) / 4. & ( 9 )\end{matrix}$$

Thus, in averaged form, the composite PSD may be written as \overline{\hat{L}}= L̅_{DB}·W. The weight vector W may then be found as the vector W that, for wₘ≧0 minimizes the square of the difference as before with an added term taking into account the averages:

$$min ( \sum {( {l}_{{λ}_{n}} - {\hat{l}}_{{λ}_{n}} )}^{2} + {α ( {\overline{l}}_{{λ}_{n}} - {\hat{\overline{l}}}_{{λ}_{n}} )}^{2} ) \qquad ( 10 )$$

where α is a weight applied to adjust the relative importance of the average term in the minimization process.

In one or more embodiments of the invention, the estimation engine (110) is configured to calculate a probability that each candidate light source is present in the environment (190). The probability (i.e., confidence level) of a candidate light source being present in the environment (190) may be based on the number of sets to which the candidate light source belongs and/or the weights assigned to the stored PSD of the candidate light source. Moreover, new sets may be generated with candidate light sources from existing sets having large weights assigned to their stored PSDs. Composite PSDs for the new sets may also be computed.

In one or more embodiments of the invention, the computing device includes a screen (103). The screen (103) may be used to output (i.e., display) the identities (i.e., type, model, brand, manufacturer, etc.) of candidate light sources. The probabilities of various candidate light sources being present in the environment (190) may also be displayed on the screen (103). In one or more embodiments of the invention, only the top three or top 5 candidate light sources are displayed to the user on the screen (103).

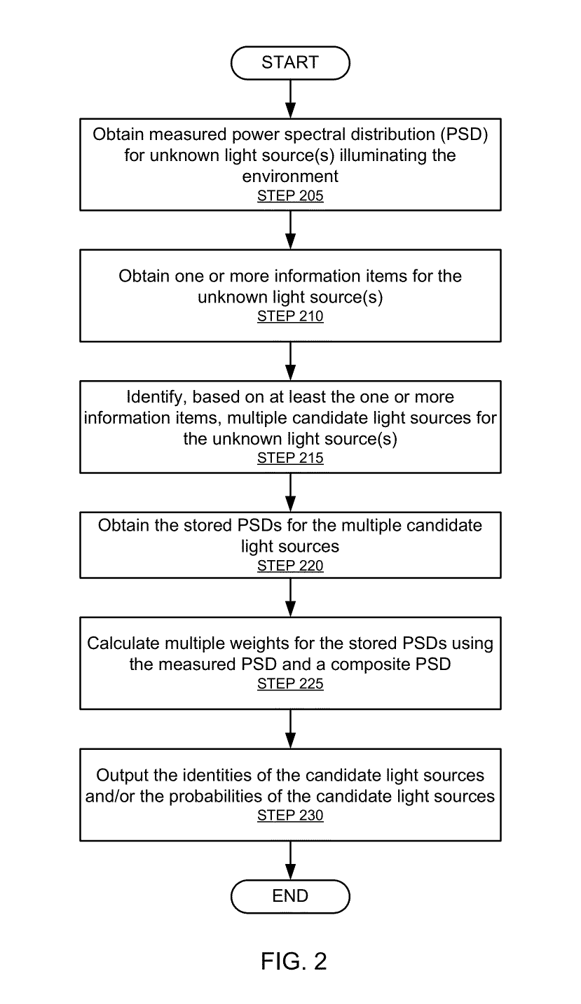

FIG. 2 shows a flowchart for light source recognition in accordance with one or more embodiments of the invention. One or more steps in FIG. 2 may be executed by the system (100) (e.g., computing device (102)). The sequence of steps shown in FIG. 2 may differ among embodiments of the invention, and one or more of the steps may be performed in parallel and/or may be optional. Moreover, one or more steps in FIG. 2 may be repeated. Accordingly, the scope of the invention should not be considered limited to the specific arrangement of steps shown in FIG. 2.

Initially, a PSD for an environment illuminated by one or more unknown light sources is measured (STEP 205). The PSD may be measured using a smart phone, tablet computer, or other computing device having a camera. In other words, the PSD may be measured using a smart phone, tablet computer, or other computing device acting as a spectrometer. For example, a slit(s) and grating may be mounted to the input of the camera, rendering the computing device a low cost spectrometer. In addition, rather than being a grating based spectrometer, the camera may be any number or types of multi-spectral cameras. For example, the PSD may be obtained using a plenoptic camera or the like. As discussed above, the PSD is a function mapping wavelengths to their relative powers in the environment.

In STEP 210, one or more information items of the unknown light source(s) are obtained. For example, a timestamp associated with the measured PSD and a geographical item associated with the environment are obtained. The timestamp may be created after measuring the PSD using a clock. The geographical item may include the global positioning system (GPS) coordinates of a point in the environment, the altitude of the environment, a compass direction, etc. As discussed above, the timestamp and/or geographical item may be used to obtain/determine/calculate other parameters associated with the environment. As yet another example, the flicker may be obtained. One or more of the parameters may be input by a user.

In STEP 215, multiple candidate light sources are identified based the one or more information items of the unknown light source (e.g., the timestamp, the geographical item, the flicker, and/or any parameter). In other words, the identified light sources are candidates for the unknown light sources illuminating the environment. In one or more embodiments of the invention, candidate light sources are identified by excluding light sources that are inconsistent with the timestamp, geographical item, etc. In one or more embodiments of the invention, light sources that are consistent with the timestamp, geographical item, etc. are considered candidate light sources. Using a small weighting factor for light source outside candidates is possible.

In STEP 220, stored PSDs for the candidate light sources are retrieved. The stored PSDs may all be normalized to an illuminance of any value (e.g., 100). The stored PSDs may be retrieved from a database that is remote to the computing device measuring the PSD, obtaining the timestamp and/or geographical item, etc.

In STEP 225, a composite PSD is generated/calculated by assigning weights to the obtained PSDs and combining (e.g., summing) the weighted PSDs. The weights may be revised repeatedly in an attempt to generate a composite PSD that matches, within some tolerance, the measured PSD. Any algorithm, linear or non-linear, may be used to determine/calculate the weights. For example, the non-linear iterative Generalized Reduced Gradient (GRG2) Algorithm may be used to determine/calculate the weights.

Those skilled in the art, having the benefit of this detailed description, will appreciate that the number of candidate light sources may exceed the number of wavelengths in the measured PSD. In such embodiments, each candidate light source may be grouped/placed/assigned into one or more sets. Moreover, the number of candidate light sources in each set is less than the number of wavelengths in the measured PSD. STEP 225 may be repeated for each set of candidate light sources. Moreover, new sets may be created with candidate light sources having large weights in from existing sets. STEP 225 may be repeated for the new sets.

The probability (i.e., confidence level) of a candidate light source being present in the environment may be based on the number of sets to which the candidate light source belongs and/or the weights assigned to the stored PSD of the candidate light source.

In STEP 230, the identities (i.e., type, model, brand, manufacturer, etc.) of candidate light sources may be outputted (e.g., displayed, printed, emailed, faxed, short messaging service (SMS), etc.). The probabilities of various candidate light sources being present in the environment may also be outputted. In one or more embodiments of the invention, only the identities of the top 3 or top 5 candidate light sources, as dictated by the probabilities, are outputted.

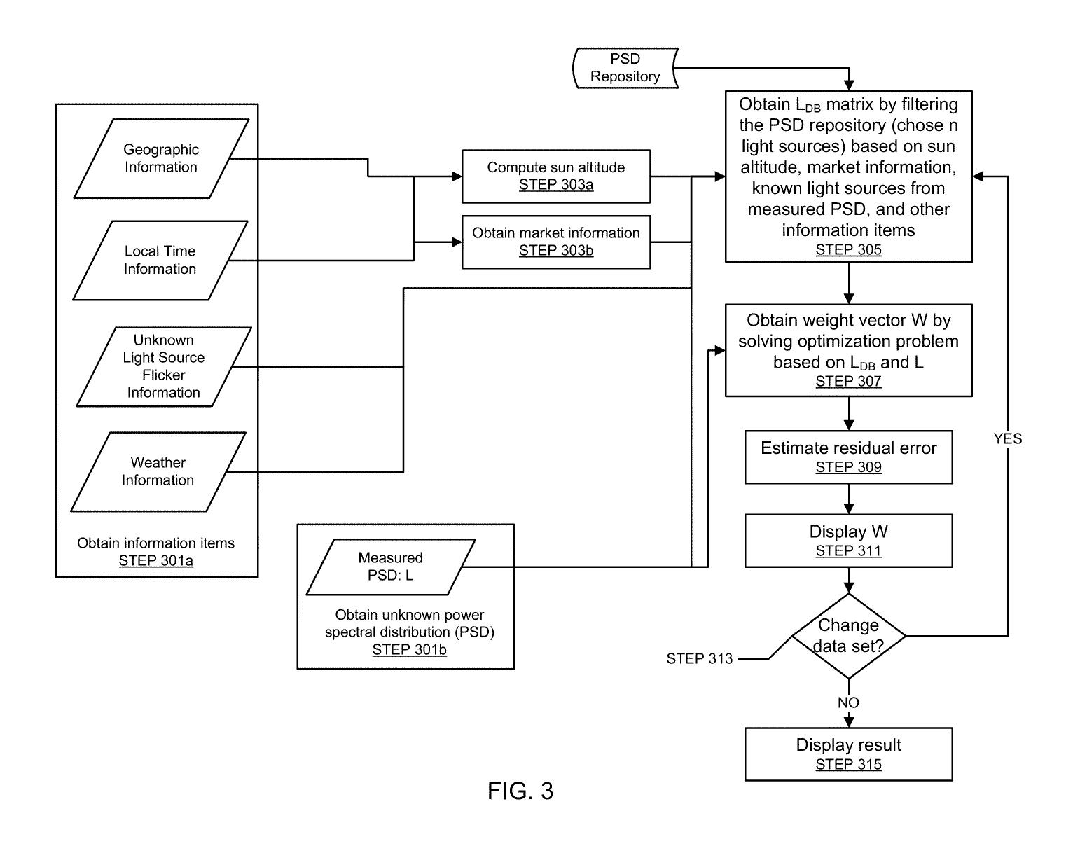

FIG. 3 shows an example workflow for a method for light source recognition in accordance with one or more embodiments. In STEP 301a, a set of information items are obtained. For example, information items may include geographic information, e.g., GPS coordinates, local time information, light source flicker information, and local weather information. In addition, before, during or after STEP 301a, an unknown light source PSD is obtained by a mobile computing device in STEP 301b. For example, the PSD may be obtained by the camera of the mobile computing device, wherein the camera is adapted to be a spectrometer, e.g., a grating based or filter based multi-spectral camera.

In STEP 303a, the geographic information and local time information is used to compute the sun altitude, i.e., the position of the sun in the sky. Furthermore, the geographical information and/or local time information are used to compute the market information related to that geographical area. For example, information relating to what light sources are used and/or sold within a particular geographical region is obtained at STEP 303b.

In STEP 305, the sun altitude, market information, in addition to the other information items are used to filter the data in the PSD repository to generated a matrix L_{DB} of candidate light sources. For example, if the geographic information indicates that the unknown PSD was obtained in Japan, standard illuminants F10-F12 may be chosen for candidate light sources because these three-wavelength (tri-band) type fluorescent lamps have a large market share in Japan. In addition, for example, if the altitude of the sun is high, the daylight illuminants D40-D200 may be chosen; or if the altitude of the sun is negative (dawn or dusk time, before sun rise or after sun set), daylight illuminants D100-D200 may be chosen. Furthermore, the user may manually input any known light sources in order to filter the PSD repository. Other information such as flicker information and weather information may be used also to filter the data in the PSD repository. While a limited set of information items are disclosed in this example for the sake of simplicity, any number of information items may be used without departing from the scope of the present disclosure.

In STEP 307 a weight vector W is obtained using the matrix L_{DB} of candidate light sources and the measured PSD. In one embodiment, the weight vector W may be found by solving Eq. (2) for W, as described above. Practically speaking, the solution may be accomplished by solving an optimization problem such as that defined by Eq. (5) and/or Eq. (10) with the constraint that wₘ≧0. Once W is computed by solving the optimization problem, the residual error is computed between the measured PSD and the composite PSD. The residual error is computed in STEP 309. In STEP 311, the weight vector W may be displayed. In STEP 313, it is determined if the data set should be changed. For example, if it is clear from the weight vector and residual error estimation that some candidate light sources should be dropped or added from the matrix L_{DB} to improve the estimated composite PSD, a decision to change the data set is made in STEP 313. The method then returns to STEP 305 and different candidate light sources may be chosen. In one embodiment, candidates that fit particularly well to the measured PSD are left in the dataset while other candidates may be dropped or added as the case may be.

In STEP 313, if the estimated residual error and W values are suitable, e.g., realistic W values and residual error less than a predetermined threshold, a decision is made to display the resulting composite PSD along with the W values. In addition, a list of the chosen candidate light sources and their probabilities (or confidence value) of occurrence as an unknown light source may also be displayed. For example, probability may be calculated by the weight values and/or the residual error between the composite PSD and the measured PSD. The bigger residual error, the smaller probability. In some instances the weight value alone can be used as probability.

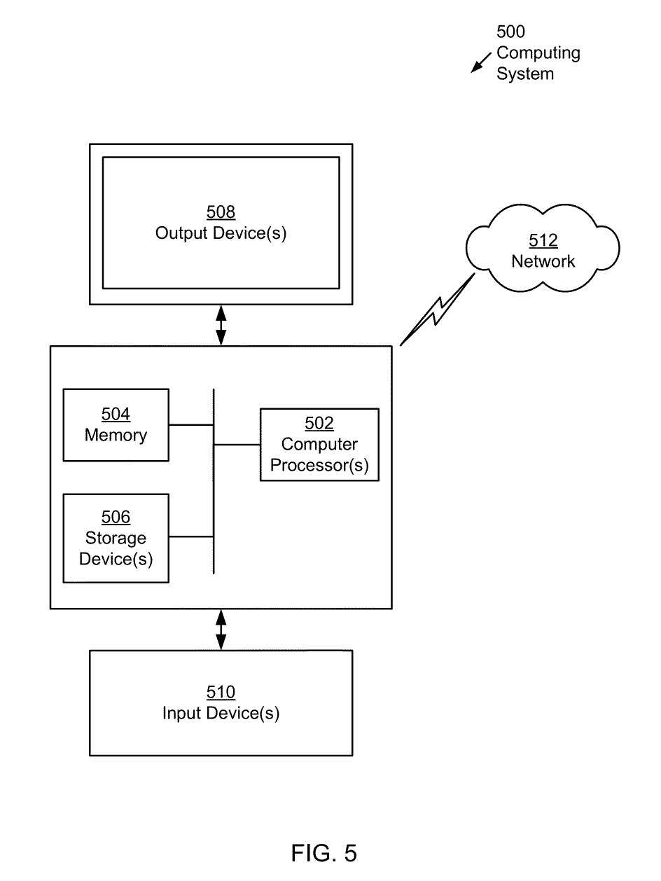

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (500) may include one or more computer processor(s) (502), associated memory (504) (e.g., random access memory (RAM), cache memory, flash memory, etc.), one or more storage device(s) (506) (e.g., a hard disk, an optical drive such as a compact disk (CD) drive or digital versatile disk (DVD) drive, a flash memory stick, etc.), and numerous other elements and functionalities. The computer processor(s) (502) may be an integrated circuit for processing instructions. For example, the computer processor(s) may be one or more cores, or micro-cores of a processor. The computing system (500) may also include one or more input device(s) (510), such as a touchscreen, keyboard, mouse, microphone, touchpad, electronic pen, or any other type of input device. Further, the computing system (500) may include one or more output device(s) (508), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (500) may be connected to a network (512) (e.g., a local area network (LAN), a wide area network (WAN) such as the Internet, mobile network, or any other type of network) via a network interface connection (not shown). The input and output device(s) may be locally or remotely (e.g., via the network (512)) connected to the computer processor(s) (502), memory (504), and storage device(s) (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (500) may be located at a remote location and connected to the other elements over a network (512). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for light source recognition in an environment, comprising:
obtaining, by a computing device, a measured power spectral distribution (PSD) for an unknown light source illuminating the environment;
obtaining, by the computing device, an information item for the unknown light source;
identifying, based on at least the information item, a plurality of candidate light sources for the unknown light source illuminating the environment;
obtaining a plurality of stored PSDs for the plurality of candidate light sources;
calculating a plurality of weights for the plurality of stored PSDs based on the measured PSD and a composite PSD, wherein the composite PSD is based on the plurality of stored PSDs; and
outputting an identity of at least one of the plurality of candidate light sources.

2. The method of claim 1, wherein the computing device comprises a spectrometer to obtain the measured PSD for the unknown light source.

3. The method of claim 2, wherein the computing device is one selected from a group consisting of a smart phone and a tablet computer.

4. The method of claim 1, wherein the information item comprises a geographic location of the environment.

5. The method of claim 1, wherein the information item comprises a timestamp associated with the measured PSD and generated using a clock of the computing device.

6. The method of claim 1, where in the information item is a flicker rate of the unknown light source.

7. The method of claim 1, wherein the information item is weather information associated with the environment and the measured PSD.

8. The method of claim 1, wherein the identifying the plurality of candidate light sources comprises:
excluding a light source in response to the light source being inconsistent with the information item.

9. The method of claim 1, further comprising computing a location of the sun in the sky based on the information item, wherein the information item comprises a geographical location of the environment and a timestamp associated with the measured PSD.

10. The method of claim 1, further comprising calculating the plurality of weights for the plurality of stored PSDs by minimizing an error value computed between the measured PSD and the composite PSD.

11. The method of claim 10, wherein the error value is a squared error value between the measured PSD and the composite PSD.

12. A system for light source recognition in an environment, comprising:
a spectrometer configured to obtain a power spectral distribution (PSD) for an unknown light source illuminating the environment;
an estimation engine executing on a processor and configured to:
identify, based on an information item of the unknown light source, a plurality of candidate light sources for the unknown light source illuminating the environment;
obtain a plurality of stored PSDs for the plurality of candidate light sources; and
calculate a plurality of weights for the plurality of stored PSDs by comparing the measured PSD with a composite PSD, wherein the composite PSD is based on the plurality of stored PSDs; and
a screen for displaying an identity of at least one of the plurality of candidate light sources.

13. The system of claim 12, wherein the spectrometer comprises a slit, a dispersive optical element, and a camera of a mobile computing device, wherein the mobile computing device comprises the screen for displaying the identity of at least one of the plurality of candidate light sources.

14. The system of claim 12, further comprising a time engine comprising a clock and configured to generate a timestamp associated with the measure PSD using the clock, wherein the information item comprises the timestamp.

15. The system of claim 12, further comprising a positioning engine configured to calculate a GPS coordinate for the environment, wherein the information item comprises the GPS coordinate for the environment.

16. A non-transitory computer readable medium (CRM) storing instructions for light source recognition in an environment, the instructions comprising functionality for:
obtaining a measured power spectral distribution (PSD) for an unknown light source illuminating the environment;
obtaining an information item of the unknown light source;
identifying, based on at least the information item, a plurality of candidate light sources for the unknown light source illuminating the environment;
obtaining a plurality of stored PSDs for the plurality of candidate light sources;
calculating a plurality of weights for the plurality of stored PSDs based on the measured PSD and a composite PSD, wherein the composite PSD is based on the plurality of stored PSDs; and
outputting an identity of at least one of the plurality of light sources.

17. The non-transitory CRM of claim 16, wherein the information item is one selected from a group consisting of a flicker rate of the unknown light source and a geographic location of the environment illuminated by the unknown light source.

18. The non-transitory CRM of claim 16, wherein the information item is one selected from a group consisting of a timestamp associated with the measured PSD and weather information corresponding to the environment illuminated by the unknown light source.

19. The non-transitory CRM of claim 16, the instructions further comprising functionality for:
computing a location of the sun in the sky based on the information item, wherein the information item comprises a geographical location of the environment and a timestamp associated with the measured PSD.

20. The non-transitory CRM of claim 16, the instructions further comprising functionality for:
calculating the plurality of weights for the plurality of stored PSDs by minimizing an error value computed between the measured PSD and the composite PSD.
